(19) United States
(12) Patent Application Publication
(10) Pub. No.: US 2025/0166507 A1
(43) Pub. Date: May 22, 2025

(54) METHOD FOR RECORDING A PARKING LOCATION OF A VEHICLE

(71) Applicant: FCA US LLC, Auburn Hills, MI (US)

(72) Inventor: Anagha U Pradhan, Troy, MI (US)

(21) Appl. No.: 18/512,614

(22) Filed: Nov. 17, 2023

(51) Int. Cl. G08G 1/123

(52) U.S. Cl. CPC G08G 1/123

(57) ABSTRACT

A method and system for recording a parking location of a vehicle. The method includes determining an occurrence of an initiating event; querying a user to enter data regarding the parking location or providing vehicle determined location data; and saving the user entered or vehicle provided data, the saved data retrievable by or available for later communication to the user. The method may further permit a user to preview images of the parking location and to add these images to the saved data. The system may utilize the vehicle on-board cameras to generate the images and the telematic device to send these images to a user mobile device. The user can enter the data via a vehicle infotainment system or via a vehicle application on a mobile device.

### FIELD

The present disclosure relates to a parking location method and system for enabling a user to record parking location data to make it easier to return to a vehicle.

### BACKGROUND

It can often be difficult for a user to locate their parked vehicle, especially in a large parking facility or after travel when there has been a significant time between when the vehicle was parked and the time when the user attempts to retrieve the vehicle. This can lead to user frustration. It would be beneficial to a user if there was a convenient method for storing information about the location of a parked car and then retrieving it at a later time.

### SUMMARY

A parking location method and system enables a user to record parking location data to make it easier to return to a vehicle. In at least some implementations, the method of recording a parking location of a vehicle comprises the steps of: determining an occurrence of an initiating event; querying a user to enter data regarding the parking location or presenting the user with vehicle generated data regarding the parking location; and saving the user entered data or the vehicle generated data, the saved data being retrievable by or presentable at a later time to the user.

In at least some implementations of the method turning off the vehicle or putting the vehicle in a park mode is the initiating event. In at least some implementations of the method further comprises presenting at least one image of the parking location to the user. In at least some implementations of the method the user is queried to accept or reject the at least one image and wherein if accepted the at least one image is added to the saved data.

In at least some implementations, the method includes providing a telematic device and at least one on-board vehicle camera and wherein the at least one image is generated by the at least one on-board camera and wherein the telematic device sends the at least one image to a mobile device.

In at least some implementations the method further comprises determining if the vehicle is at a no record location, and wherein the user is not queried to enter data regarding the parking location if the vehicle is at a no record location.

In at least some implementations, the method includes providing a vehicle Global Positioning System (GPS) device, the vehicle GPS device providing a vehicle location and wherein the method further comprises comparing the vehicle location to a predetermined list of at least one no record locations.

In at least some implementations the method comprises providing a vehicle infotainment system with a user interface and wherein the query to the user is displayed on the infotainment system and wherein the user enters data regarding the parking location into the infotainment system through the user interface.

In at least some implementations the method comprises providing a telematic device in communication with the infotainment system and wherein the telematic device communicates the user entered data to a mobile device.

In at least some implementations the method comprises providing at least one on-board camera in communication with the infotainment system and the telematic device, wherein the on-board camera sends at least one image to the infotainment system, and wherein if a user accepts the at least one image the telematic device sends the at least one image to the mobile device.

In at least some implementations the system for recording a parking location of a vehicle comprises: a telematic device configured to communicate with a user mobile device; a vehicle Global Positioning System (GPS) device in communication with the telematic device; at least one on-board camera in communication with the telematic device; and wherein the telematic device is configured to communicate with a user mobile device over a cellular network or WiFi and wherein the telematic device is configured to send at least one image generated by the at least one on-board camera to the mobile device for viewing by the user.

In at least some implementations, the system further comprises a vehicle infotainment system having a user interface and in communication with the at least one on-board camera, wherein the infotainment system is configured to display the at least one image generated by the on-board camera.

In at least some implementations of the system the telematic device is configured to send data entered through the user interface to the mobile device.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic showing components of an embodiment of the disclosed parking location method; and

FIG. 2 is a flow diagram of a parking location method for recording a location of a vehicle.

### DETAILED DESCRIPTION

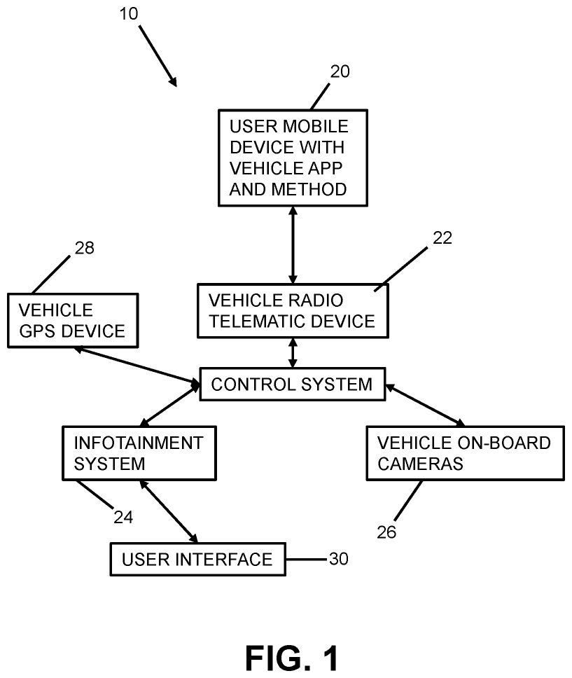

FIG. 1 is a schematic showing a system 10 that may be used in at least some embodiments of a parking location method 12. The disclosed method 12 allows a user or a vehicle to record details of a parking location for the vehicle. Modern vehicle manufacturers generally have a vehicle application (“vehicle app”) that can be loaded onto a mobile device 18, such a cell phone, and is available for a user of a vehicle. When setting up the vehicle app a user may enter identifying information, such as a Vehicle Identification Number (VIN), and this associates the vehicle app with a particular vehicle. The vehicle app can be used by the manufacture to push notifications to a user, to deliver details regarding the status of vehicle systems, and to allow a user to interact with the vehicle and vehicle systems, schedule service appointments and the like.

The vehicle app works in conjunction with a vehicle control system 20 via a vehicle's telematic device 22 over a wireless communication system such as a cellular network or WiFi to allow for communication between the vehicle and the user. The control system 20 may also communicate with a vehicle infotainment system 24, one or more vehicle on-board cameras 26 and a vehicle Global Positioning System (GPS) device 28. The vehicle on-board cameras 26 may be part of an Advanced Driver Assistance System (ADAS) on the vehicle. The infotainment system 24 displays a user interface 30 via a display screen wherein a user can enter data into the infotainment system 24 for use in the method 12 and otherwise.

The control system 20 may include one or more controllers or processors. In order to perform the prescribed functions and desired processing, as well as the computations therefore (e.g., the parking location method 12 and related steps), the control system 20 may include, but not be limited to, a processor(s), computer(s), DSP(s), memory, storage, register(s), timing, interrupt(s), communication interface(s), and input/output signal interfaces, and the like, as well as combinations comprising at least one of the foregoing. “Memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

In at least some implementations, the parking location method 12 uses the vehicle app for communication with the user to control the method 12 and to allow the user to interact with the telematic device 22 and other vehicle systems like the infotainment system 24, on-board cameras 26, and vehicle GPS device 28. The telematic device may also communicate with the user via email, text message or other communication interface to provide information to the user about a vehicle location or other information, as desired.

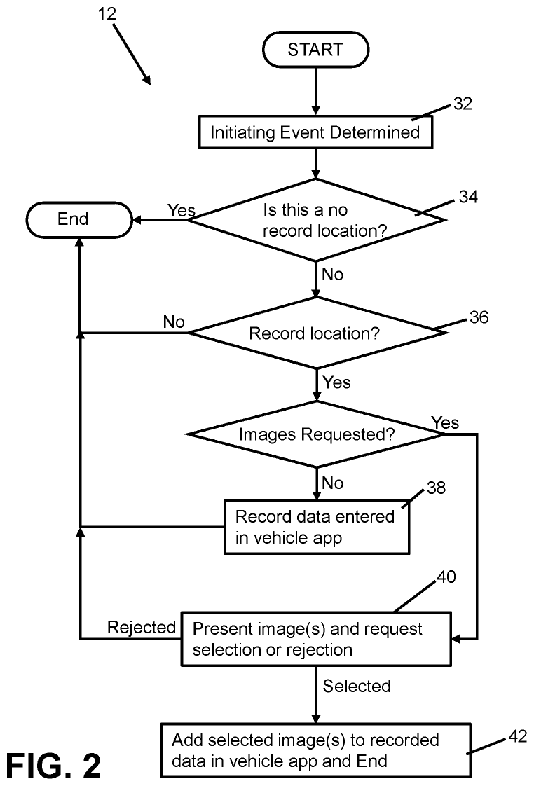

FIG. 2 shows a flow chart of the parking location method 12 in which, after an initiating event is determined in step 32, the method 12 verifies in step 34, via the GPS device 28 for example, that the vehicle is not in a location that has been designated as a no record location. The initiating event for the method 12 may be turning off of the vehicle, putting the vehicle in a park mode or setting, or actuating a park location interface via the infotainment system or vehicle app. The no record location(s) are locations that may be provided by a user where the user does not want to have the method 12 operate. For example, a user might not want to record the parking location information when they are at their home as the vehicle is easily located. Likewise other locations might be designated as no record locations such as a place of work, a child's school or other familiar locations. When the vehicle is in such a designated location the method 12 may end after determining the vehicle is in a no record location.

If the vehicle is not in a no record location, the method 12 may query the user in step 36 to determine if the user wants to record the parking location details. If the user selects no, then the method 12 ends. If the user selects yes, then the method 12 may present a data entry interface wherein the user can enter details regarding the parking location. For example, the user might enter “Row 2 Section E”, or “Level 4 North East corner” or any other data that will help a user remember the parking location. This may be done via the vehicle app, the infotainment system, or otherwise as desired. Additionally, or instead, the system may present to the user vehicle generated data (which may come from the vehicle location device like the GPS device or a navigation program, or the vehicle app, for example) relating to the location of the vehicle and query the user as to whether that data should be saved. The data may include GPS data and/or a map with an icon indicating the location of the vehicle (e.g. a dot or vehicle icon displayed within a parking lot shown on a map of a navigation program). The user may choose to store the vehicle generated data as is or may edit the information or include separate user generated data, as desired.

The method 12 may also ask the user in step 38 if one or more images of the parking location are desired. If a user answers no, then the method 12 records the data entered via the data entry interface, which can be retrieved at a later time by a user via the vehicle app, or sent to the vehicle via any desired communication protocol (e.g. text message, email, etc). The method 12 then ends. If the user answers yes to the query about an image then the method 12 may, in step 40, utilize one or more of the on-board cameras 26 to acquire images of the area surrounding the vehicle, and via the telematic device 22 may present the user with one or more images of the area around the vehicle. These images can include a forward view, a rear view, a side view, a surround or 360-degree view, an overhead view or any combination thereof. The user can then select one or more of the images and these will be added to the recorded data in step 42, which can later be retrieved by a user via the vehicle app or other interface. Once the user accepts or rejects one or more of the images the method 12 may end.

When a user wishes to retrieve the parking location information the user may open the vehicle app wherein the entered data and any selected images are available for review to help the user locate the vehicle. The user may also query the vehicle via the telematic device and retrieve information stored in the vehicle regarding the vehicle location, including GPS data and/or images. Further, in at least some implementations, the system may be effective to permit a user to request that vehicle control system to have an image taken when the user is remotely located from the vehicle, to help the user locate the vehicle. That is, the system may be operative to be woken up and to actuate the vehicle camera(s) 26 to enable an image to be taken when a user is seeking to return to the vehicle or anytime as desired.

As discussed, the user can designate one or more locations as no record locations. To accomplish this, when the user is at a location that they wish to designate as a no record location they can open the parking location method 12 on the vehicle app and they will be presented with an option to designate the location as a no record location. Or, the vehicle control system may query the user when the vehicle is put into park mode/gear, and then learn the user preference regarding various locations so that the user is not repeatedly queried in familiar or often visited locations. The system and method 12 may use the vehicle GPS device 28 or a location feature or device of the mobile device 18 to determine the location and designate the location as a no record location.

The system and method 12 may also allow a user to set up an area as a no record location by allowing the user to add a distance to the GPS designated location. So, for example the user can set a distance of 50 yards and thus the no record location will be all positions within 50 yards of the GPS determined position. After a user has designated one or more no record locations, the method 12 determines as a first step after an initiating event if the vehicle is in a no record location. It does this by comparing the current location as provided by the vehicle GPS device to the list of no record locations.

The system and method 12 also allows a user the option to turn off the parking location method/interface for any length of time. Thus, a user may be engaged in travel which will result in a series of initiating events, repeated stopping and starting of the vehicle, and not wish to be bothered with the query each time the vehicle is turned off. In this case the user can enter the method 12 through the vehicle app, or vehicle infotainment system, and turn it off for a designated period of time or until it is turned on again by the user. The method 12 also allows a user to record parking information even if in a designated no record location by allowing the user to enter the parking location data and select images even when in a designated no record location or area via the vehicle app or vehicle infotainment system.

The method 12 has been described as working exclusively through the vehicle app; however, portions of the method 12 can also be accessed and used through the vehicle infotainment system 24. For example, if an initiating event has been determined and the vehicle is not in a no record location, the vehicle infotainment system 24 can display the query to the user asking if the user wants to record the parking details and present a data entry box. The infotainment system 24 allows a user to enter data into the data interface which may include various menu options. The infotainment system 24 can also query if an image is desired and display the available images from the on-board cameras 26 if the user indicates that an image is desired. Once the user has entered the data and accepted or declined the images the infotainment system 24 interacts with the telematic device 22 to send the parking location information to the method 12 on the vehicle app. Thus, the method 12 comprises two ways for a user to enter data into the method 12. Similarly, the vehicle infotainment system 24 can be used in conjunction with the vehicle GPS device 28 to designate no record locations, or it can be used to control other parameters of the method 12 such as the period of time when the method 12 is shut off.

What is claimed is:

1. A method of recording a parking location of a vehicle comprising the steps of:
determining an occurrence of an initiating event;
querying a user to enter data regarding the parking location or presenting vehicle generated data regarding the parking location; and
saving the user entered data or vehicle generated data, the saved data being retrievable by the user.

2. The method according to claim 1, wherein turning off the vehicle is the initiating event.

3. The method according to claim 1, further comprising presenting at least one image of the parking location to the user.

4. The method according to claim 3, wherein the user is queried to accept or reject the at least one image and wherein if accepted the at least one image is added to the saved data.

5. The method according to claim 4, comprising providing a telematic device and at least one on-board vehicle camera and wherein the at least one image is generated by the at least one on-board camera and wherein the telematic device sends the at least one image to a mobile device.

6. The method according to claim 1, further comprising determining if the vehicle is at a no record location, and wherein the user is not queried to enter data regarding the parking location if the vehicle is at a no record location.

7. The method according to claim 6 comprising providing a vehicle Global Positioning System (GPS) device, the vehicle GPS device providing a vehicle location and wherein the method further comprises comparing the vehicle location to a predetermined list of at least one no record locations.

8. The method according to claim 1 comprising providing a vehicle infotainment system with a user interface and wherein the query to the user is displayed on the infotainment system and wherein the user enters data regarding the parking location into the infotainment system through the user interface.

9. The method according to claim 8 comprising providing a telematic device in communication with the infotainment system and wherein the telematic device communicates the user entered data to a mobile device.

10. The method according to claim 9 comprising providing at least one on-board camera in communication with the infotainment system and the telematic device, wherein the on-board camera sends at least one image to the infotainment system, and wherein if a user accepts the at least one image the telematic device sends the at least one image to the mobile device.

11. The method of claim 1 wherein the initiating event is putting the vehicle into a park mode.

12. A system for recording a parking location of a vehicle comprising:
a telematic device configured to communicate with a user mobile device;
a vehicle Global Positioning System (GPS) device in communication with the telematic device;
at least one on-board camera in communication with the telematic device; and
wherein the telematic device is configured to communicate wirelessly with a user mobile device and wherein the telematic device is configured to send at least one image generated by the at least one on-board camera to the mobile device for viewing by the user.

13. The system according to claim 12, further comprising a vehicle infotainment system having a user interface and in communication with the at least one on-board camera, wherein the infotainment system is configured to display the at least one image generated by the on-board camera.

14. The system according to claim 12 wherein the telematic device is configured to send data entered through the user interface to the mobile device.
